(19) United States
(12) Patent Application Publication
(10) Pub. No.: US 2014/0123820 A1
(43) Pub. Date: May 8, 2014

(54) Process of manufacturing a feed screw

(71) Applicant: NINGBO ZHENMING SHAFT CO., LTD., Ningbo (CN)

(72) Inventor: Le Le, Ningbo (CN)

(73) Assignee: Ningbo Zhenming Shaft Co., Ltd., Ningbo (CN)

(21) Appl. No.: 13/786,489

(22) Filed: Mar. 6, 2013

(30) Foreign Application Priority Data
Nov. 5, 2012 (CN) 201210437103.5

(51) Int. Cl. B23B 1/00

(52) U.S. Cl. CPC B23B 1/00
USPC 82/1.11

(57) ABSTRACT

A process of manufacturing a feed screw includes the steps of arranging three dies spaced apart 120-degree each other so as to limit a radial movement of an elongated blank feeding through a space defined by the dies; clockwise rotating the dies to cut threads on the blank; performing a thread grinding on the threads of the blank; and cutting the blank into a finished feed screw per predetermined period of time. The blank is fed through a sleeve for positioning prior to the blank feeding. Cylindrical degree of the finished feed screw is less than 0.1 mm/1,000 mm and its pitch error is 0.05 mm/100 threads.

### BACKGROUND OF THE INVENTION

1. Field of the Invention

The invention relates to processes of manufacturing screws and more particularly to a process of manufacturing a feed screw which is useful to move materials in applications such as hospitals, offices, rescue operations, and furniture.

2. Description of Related Art

There are a number of conventional feed screws used to move materials in applications such as hospitals, offices, rescue operations, and furniture. The conventional feed screws are characterized by slenderness, large pitch, many heads, and large pitch. Feed screws for moving materials in applications such as hospitals, offices, rescue operations, and furniture are required to have improved precision. Thus, the feed screw is required to be positioned precisely, move quickly, stably, and robust. Therefore, the essential part for devices used for moving materials in applications such as hospitals, offices, rescue operations, and furniture, i.e., the feed screw should be high in both precision and strength. However, feed screws made by conventional processes do not meet the requirements. In a conventional two-die cylindrical thread rolling process, two spaced dies are flush each other with a blank passing through a gap between the blank. Thus, the blank may move upward or downward when the dies rotate in the process. Upper and lower stop plates can be employed to minimize the upward or downward movement of the blank. However, the adjustment of the upper and lower stop plate is manual, resulting in errors which in turn can lower precision and quality, reduce the useful life of the dies, and reducing yield. Thus, the need for improvement still exists.

### SUMMARY OF THE INVENTION

It is therefore one object of the invention to provide a process of manufacturing a feed screw comprising the steps of arranging three dies spaced apart 120-degree each other so as to limit a radial movement of an elongated blank feeding through a space defined by the dies; clockwise rotating the dies to cut threads on the blank; performing a thread grinding on the threads of the blank; and cutting the blank into a finished feed screw per predetermined period of time.

In a first aspect of the invention, the blank is fed through a sleeve for positioning prior to the blank feeding.

In a second aspect of the invention, the finished feed screw passes through a sleeve for positioning after the cutting.

In a third aspect of the invention, cylindrical degree of the finished feed screw is less than 0.1 mm/1,000 mm and its pitch error is 0.05 mm/100 threads.

In a fourth aspect of the invention, the thread grinding and the cutting are performed after finding that the finished feed screws meet the requirements of cylindrical degree and pitch error for a feed screw.

The above and other objects, features and advantages of the invention will become apparent from the following detailed description taken with the accompanying drawings.

### BRIEF DESCRIPTION OF THE DRAWINGS

FIG. 1 is a side elevation a feed screw made by a process of manufacturing a feed screw according to the invention.

### DETAILED DESCRIPTION OF THE INVENTION

A process of manufacturing a feed screw in accordance with the invention comprises the steps of arranging three dies spaced apart 120-degree each other so as to limit a radial movement of an elongated blank feeding through a space defined by the dies, clockwise rotating the dies to cut threads on the blank, performing a thread grinding on the threads of the blank, and cutting the blank into a finished feed screw per predetermined period of time.

Preferably, the blank is fed through a sleeve for positioning prior to feeding the blank into the space among the dies.

Alternatively, the finished feed screw passes through a sleeve for positioning after finishing.

Preferably, cylindrical degree of the finished feed screw of the invention is less than 0.1 mm/1,000 mm and its pitch error is 0.05 mm/100 threads. To the contrary, cylindrical degree of the feed screw made by the conventional process is 2 mm/1,000 mm and its pitch error is 0.5 mm/100 threads. The thread grinding and cutting steps are performed after finding that the feed screws of the invention meet the requirements of cylindrical degree and pitch error for a feed screw.

The feed screw of the invention has a diameter between 10 mm and 40 mm, a length between 100 mm and 4,000 mm, a pitch between 0.5 mm and 10 mm, the number of heads between 1 and 7, and a lead between 1 mm and 35 mm.

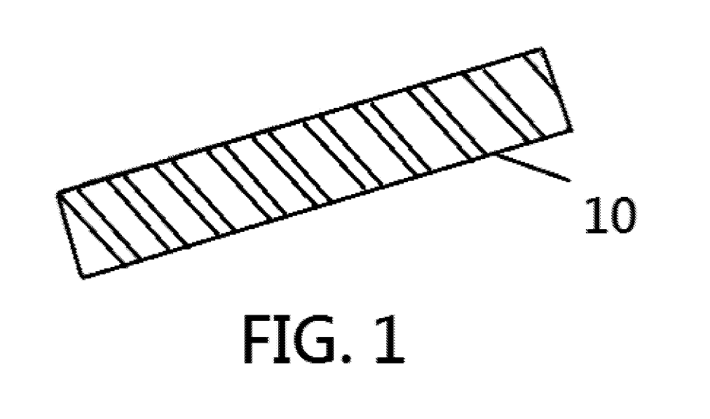

Referring to FIG. 1, the finished feed screw of the invention is designated 10.

The feed screw of the invention has the advantages of increased hardness, increased load, and increased precision.

While the invention has been described in terms of preferred embodiments, those skilled in the art will recognize that the invention can be practiced with modifications within the spirit and scope of the appended claims.

What is claimed is:

1. A process of manufacturing a feed screw comprising the steps of:
arranging three dies spaced apart 120-degree each other so as to limit a radial movement of an elongated blank feeding through a space defined by the dies;
clockwise rotating the dies to cut threads on the blank;
performing a thread grinding on the threads of the blank; and
cutting the blank into a finished feed screw per predetermined period of time.

2. The process of claim 1, wherein the blank is fed through a sleeve for positioning prior to the blank feeding.

3. The process of claim 1, wherein the finished feed screw passes through a sleeve for positioning after the cutting.

4. The process of claim 3, wherein cylindrical degree of the finished feed screw is less than 0.1 mm/1,000 mm and its pitch error is 0.05 mm/100 threads.

5. The process of claim 4, wherein the thread grinding and the cutting are performed after finding that the finished feed screws meet the requirements of cylindrical degree and pitch error for a feed screw.
